(19) United States
(12) Patent Application Publication
(10) Pub. No.: US 2016/0300108 A1
(43) Pub. Date: Oct. 13, 2016

(54) IRIS ACQUISITION USING VISIBLE LIGHT IMAGING

(71) Applicant: Motorola Mobility LLC, Chicago, IL (US)

(72) Inventors: Lawrence A. Willis, Dubuque, IA (US); Justin Eltoft, Pleasant Prairie, WI (US); Jiri Slaby, Buffalo Grove, IL (US)

(21) Appl. No.: 14/681,891

(22) Filed: Apr. 8, 2015

(51) Int. Cl. G06K 9/00; G06K 9/22; H04N 5/232; H04N 5/225; H04N 5/33

(52) U.S. Cl. CPC G06K 9/00604; H04N 5/2256; H04N 5/33; H04N 5/23219; G06K 9/0061; G06K 9/22

(57) ABSTRACT

In embodiments of iris acquisition using visible light imaging, a mobile device includes a front-facing camera device with a light that can be used to project visible light to illuminate a face of a user of the mobile device. An eye location module can determine that the user is wearing glasses utilizing ambient light or the projected visible light. The eye location module can determine a center point of a lens of the glasses and initiate an LED system to project near infra-red light to illuminate at least one eye of the user. The near infra-red light is projected to encompass the determined center point of the lens effective to illuminate a pupil of the eye. The eye location module can locate the pupil of the eye based on a reflection of the near infra-red light from the pupil at approximately the determined center point of the lens.

### BACKGROUND

Portable devices, such as mobile phones, tablet devices, digital cameras, and other types of computing and electronic devices can typically run low on battery power, particularly when a device is utilized extensively between battery charges and device features unnecessarily drain battery power. For example, some devices may be designed for various types of user authentication methods to verify that a user is likely the owner of the device, such as by entering a PIN (personal identification number), or by fingerprint recognition, voice recognition, face recognition, heartrate, and/or with an iris authentication system to authenticate the user. Iris recognition is a form of biometric identification that uses pattern-recognition of one or both irises of the eyes of the user. Individuals have complex, random, iris patterns that are unique and can be imaged from a distance for comparison and authentication.

However, some of the authentication methods utilize the battery power of a device, and some may unnecessarily drain the battery power. For example, an iris authentication system may activate to illuminate the face of a user, and an imager activates to capture an image of the eyes of the user, even when the device is not properly orientated or aimed for useful illumination and imaging. Iris acquisition and subsequent authentication performance can differ depending on the eye illumination quality. Further, an iris authentication system has relatively high power requirements due to near infra-red (NIR) LED and imager use, yet presents advantages over the other authentication methods, such as security level, accuracy, potential for seamless use, and use in many environments (e.g., cold, darkness, bright sunlight, rain, etc.).

Iris acquisition and authentication utilizes reflected near infra-red (NIR) light (e.g., from LEDs) to locate an eye of a user and then image the iris of the eye. The NIR illumination is used to image the iris of an eye, but utilizes device battery power to generate the NIR illumination, image the iris, and compare the captured image for user authentication. Further, the speed of iris acquisition may be impacted by a user who is wearing various types of glasses, where the frames and/or lenses of the glasses present multiple reflection points back to the NIR imager, which introduces a search latency in being able to determine the reflection point that corresponds to a pupil of the eye so that the iris can be efficiently acquired and authenticated.

### BRIEF DESCRIPTION OF THE DRAWINGS

Embodiments of iris acquisition using visible light imaging are described with reference to the following Figures. The same numbers may be used throughout to reference like features and components that are shown in the Figures:

FIG. 1 illustrates an example mobile device in which embodiments of iris acquisition using visible light imaging can be implemented.

FIG. 2 further illustrates examples of iris acquisition using visible light imaging in accordance with one or more embodiments.

FIGS. 3A and 3B illustrate example method(s) of iris acquisition using visible light imaging in accordance with one or more embodiments.

FIG. 4 illustrates various components of an example device that can implement embodiments of iris acquisition using visible light imaging.

### DETAILED DESCRIPTION

Embodiments of iris acquisition using visible light imaging are described, such as for any type of mobile device that may be implemented with an infra-red (IR) processing system that is utilized for gesture recognition and/or iris authentication of a user of the mobile device. However, iris acquisition can be impacted by a user who is wearing glasses, where the frames and/or lenses of the glasses present multiple reflection points back to a near infra-red (NIR) imager. The multiple reflection points can introduce latency in being able to determine the reflection point that corresponds to a pupil of the eye so that the iris can be acquired and authenticated.

In aspects of iris acquisition using visible light imaging, a mobile device can utilize an integrated front-facing visible light camera and/or ambient light in parallel with the NIR imager to determine an approximate location of the pupil of an eye (or the pupils of both eyes) of a user of the device, and the approximate location of the pupil can be used as seed location data for an NIR imaging system so that the eye can be imaged for iris authentication more efficiently. In implementations that use a single imager for both visible light and NIR light imaging, the steps would be sequenced accordingly. The visible light camera can be used to illuminate the face of the user of the device if the ambient light conditions do not provide adequate illumination, and an eye location module determines the approximate location of the pupil of the eye (or both eyes) of the user of the device when the user is wearing glasses, such as any type of reading glasses, sunglasses, goggles, and the like.

The eye location module can implement algorithms and other techniques for face detection and computer vision to determine whether the user is wearing glasses. If glasses are detected, the eye location module can then bisect each lens of the glasses horizontally and vertically to determine a center x-y point of each lens, from which the closest reflection point of NIR light is determined. The closest NIR light reflection point to the center of a lens of the glasses can be used to approximate the location of the iris of the pupil of the eye (or eyes) of the user, from which an image of the eye can be captured for iris authentication. In embodiments, determining the center point of a lens (or the lenses) of the glasses can be performed approximately simultaneously with locating the pupil of the eye (or eyes) of the user based on the reflection of the NIR from the pupil.

While features and concepts of iris acquisition using visible light imaging can be implemented in any number of different devices, systems, environments, and/or configurations, embodiments of iris acquisition using visible light imaging are described in the context of the following example devices, systems, and methods.

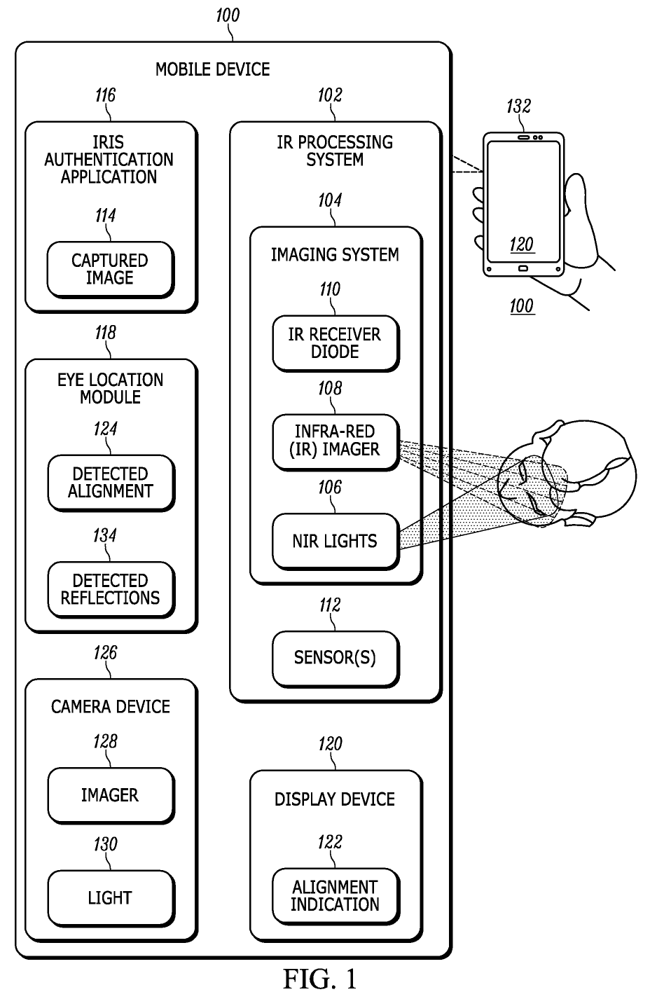

FIG. 1 illustrates an example mobile device 100 in which embodiments of iris acquisition using visible light imaging can be implemented. The example mobile device 100 may be any type of mobile phone, tablet device, digital camera, or other types of computing and electronic devices that are typically battery powered. In this example, the mobile device 100 implements components and features of an infra-red (IR) processing system 102 that can be utilized for gesture recognition and/or iris authentication of a user of the mobile device. The IR processing system 102 includes an imaging system 104 with near infra-red (NIR) lights 106 (such as LEDs), an IR imager 108, and an IR receiver diode 110. Although shown as a component of the IR processing system 102 in this example, the IR imaging system 104 may be implemented in the mobile device 100 separate from the IR processing system. The IR processing system 102 can also include one or more sensors 112, such as proximity sensors that detect the proximity of a user to the mobile device and/or an ambient light sensor that detects the ambient light conditions proximate the mobile device.

The NIR lights 106 can be implemented as a LED, or as a system of LEDs, that are used to illuminate features of a user of the mobile device 100, such as for gesture recognition and/or iris authentication, or other NIR-based systems. Generally, the LED system (e.g., of the NIR lights 106) includes one or more LEDs used to illuminate the face of the user, and from which an alignment of the face of the user with respect to the mobile device can be detected. The NIR lights 106 can be used to illuminate the eyes of the user, and the IR imager 108 is dedicated for eye imaging and used to capture an image 114 of an eye (or both eyes) of the user. The captured image 114 of the eye (or eyes) can then be analyzed for iris authentication with an iris authentication application 116 implemented by the mobile device. The mobile device 100 also implements an eye location module 118 that includes algorithms and other techniques for face and eyeglass detection, and is further described below with reference to features of iris acquisition and authentication.

The iris authentication application 116 and the eye location module 118 can each be implemented as a software application or module, such as executable software instructions (e.g., computer-executable instructions) that are executable with a processing system of the device in embodiments of iris acquisition using visible light imaging. The iris authentication application 116 and the eye location module 118 can be stored on computer-readable storage memory (e.g., a memory device), such as any suitable memory device or electronic data storage implemented in the mobile device. Although shown as separate components, the eye location module 118 may be integrated as a module of the iris authentication application 116. Further, the iris authentication application 116 and/or the eye location module 118 may be implemented as components of the IR processing system 102.

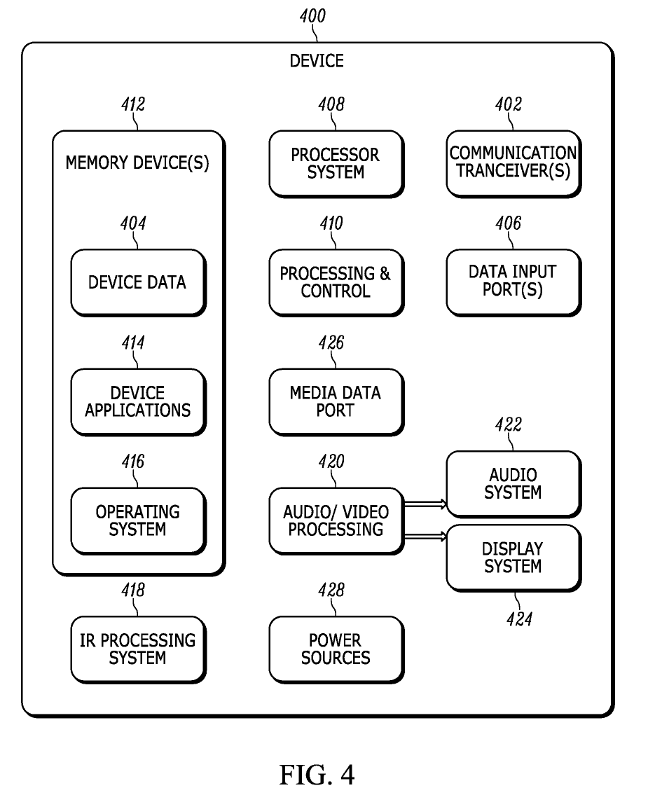

Additionally, the mobile device 100 can be implemented with various components, such as a processing system and memory, an integrated display device 120, and any number and combination of various components as further described with reference to the example device shown in FIG. 4. As further described below, the display device 120 can display an alignment indication 122, such as displayed in an interface of the IR processing system 102. The alignment indication 122 can indicate a direction to turn the device and assist a user of the mobile device 100 with achieving a correct alignment of the face of the user with respect to the mobile device so that an image of an eye (or eyes) of the user can be captured for iris authentication by the iris authentication application 116. The alignment indication 122 can be initiated and displayed based on a detected alignment 124 by the eye location module 118.

In this example, the mobile device 100 also includes a camera device 126 that is utilized to capture digital images, and the camera device 126 includes an imager 128 to capture a visible light digital image of a subject. In alternate implementations, the IR imager 108 of the IR processing system 102 and the camera imager 128 can be combined as a single imager of the mobile device 100 in a design that may be dependent on IR filtering, imaging algorithm processing, and/or other parameters. The camera device also includes a light 130, such as a flash or LED, that emits visible light to illuminate the subject for imaging, such as when the ambient light conditions do not provide adequate illumination.

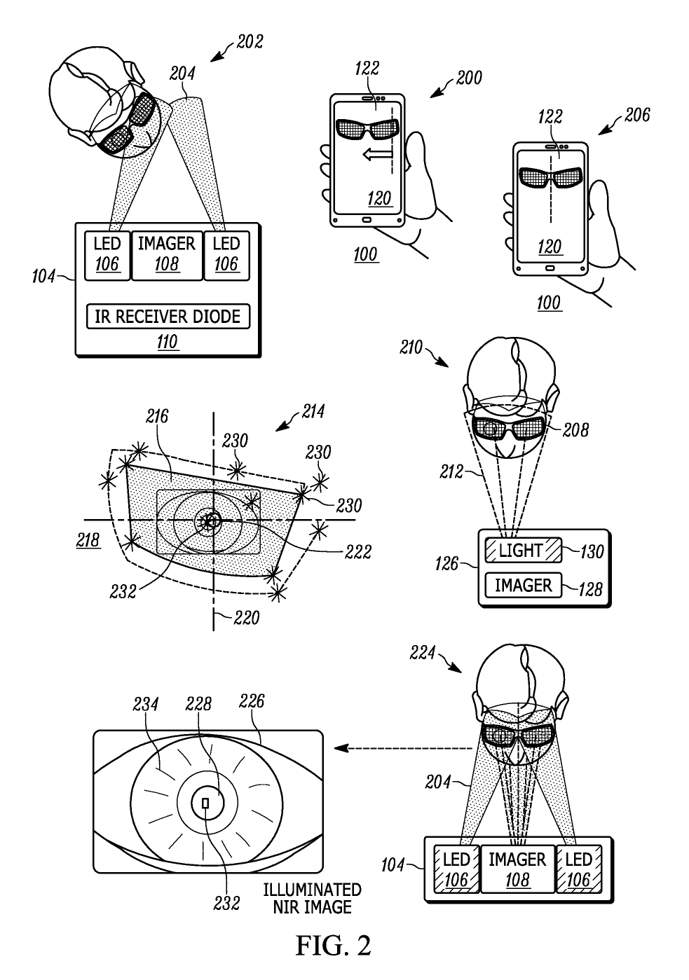

The camera device 126 can be integrated with the mobile device 100 as a front-facing camera with a lens 132 that is integrated in the housing of the mobile device and positioned to face the user when holding the device, such as to view the display screen of the display device 120. As further shown and described with reference to FIG. 2, the light 30 of the camera device 126 emits a visible light that can be used to illuminate the face of a user who is wearing glasses, and the imager 128 of the camera device used to capture image data containing the face of the user, an eyeglass frame, and the lenses of the glasses. The eye location module 118 can then locate the eyeglass frame and lenses that are imaged with the camera device.

FIG. 2 illustrates examples 200 of iris acquisition using visible light imaging as described herein. As shown at 202, the imaging system 104 of the mobile device 100 includes the IR imager 108, the IR receiver diode 110, and an LED system (e.g., of the NIR lights 106) that are used to illuminate the face of a person (e.g., a user of the mobile device 100) with near infra-red light 204. The eye location module 118 can detect the alignment 124 of the face of the user with respect to the mobile device 100 based on the reflections of the LEDs (e.g., the illumination generated by the NIR lights 106 reflected from the user). The alignment of the face of the user with respect to the mobile device 100 can be detected by assessing an origin of the emitted lights, where two or more of the LEDs are serialized and each LED transmits in a dedicated time slot in a time-division multiple access (TDMA) system. Based on an assessment of all the reflected LED lights, the system detects whether the head of the user is in a desired viewing angle. In an implementation, all of the LEDs can transmit the same pulse, but in different time slots. In other implementations, the LEDs are designed to each transmit a unique code (e.g., a unique LED signature).

The eye location module 118 determines the alignment 124 of the face of the user with respect to the mobile device 100 based on the detected reflections 134 of the illumination from the LEDs (e.g., the NIR lights 106 reflected from the user). Two or more of the LEDs can be used to illuminate the face of the user, and the IR receiver diode 110 receives the reflected light, from which the origins of the reflected light are assessed by the eye location module 118 to determine an orientation of the head of the user. As shown at 202, the face of the user is not aligned with the imaging system 104 of the mobile device 100, and the alignment indication 122 is displayed in an interface on the display device 120 of the mobile device. Here, the alignment indication is shown as a dashed line with an arrow to direct the user which way to move the mobile device so that the dashed line is centered between the eyes as displayed in a preview of the eyes (e.g., a video preview or a still image preview).

As shown at 206, the alignment indication 122 assists the user of the mobile device 100 with achieving a correct alignment of the face of the user with respect to the device so that an image of an eye (or eyes) of the user can be captured for iris authentication by the iris authentication application 116. At 206, the alignment indication 122 that is displayed in the interface on the display device 120 of the mobile device 100 shows a correct alignment of the face of the user with respect to the mobile device, and the eye location module 118 can determine the correct alignment for iris authentication.

In implementations of iris authentication using visible light imaging, the eye location module 118 can determine that a user of the mobile device 100 is wearing glasses 208, such as any type of reading glasses, sunglasses, goggles, and the like. The face of the user of the mobile device 100 can be illuminated utilizing the ambient light; by changing the display device 120 to a white or other illuminating color; or as described above and shown at 210, by projecting visible light 212 with the light 130 (e.g., a flash or LED) of the front-facing camera device 126. This visible light source can be used in instances when an ambient light sensor (e.g., a sensor 112) detects that there is not sufficient ambient light to illuminate the face of the user. The light 130 of the camera device 126 emits the visible light 212 used to illuminate the face of a user who is wearing the glasses, as shown at 210. The imager 128 of the camera device 126 can be used to capture a visible light image of the glasses frame and lenses, as shown at 214, and known algorithms and other techniques for face and eyeglass detection can be implemented by the eye location module 118.

When a determination is made that a user of the mobile device 100 is wearing glasses 208, the eye location module 118 is implemented to bisect a lens 216 (or both lenses) of the glasses horizontally 218 and vertically 220 to determine a center point 222 of the lens of the glasses. As shown at 224, the eye location module 118 can initiate one or more LEDs of the LED system (e.g., the NIR lights 106) to project the near infra-red light 204 to illuminate an eye 226 (or both eyes) of the user, and the near infra-red light is projected to encompass the determined center point 222 of the lens 216 of the glasses effective to illuminate a pupil 228 of the eye. As further shown at 214, the frames and/or lenses 216 of the glasses can present multiple reflection points 230 back to the NIR imager 108.

The eye location module 118 can determine an approximate location of the pupil 228 of the eye 226 of a user of the device, and the approximate location of the pupil can be used as seed location data to the eye location module 118 so that the eye can be imaged for iris authentication more efficiently. In implementations, the eye location module 118 can locate the pupil 228 of the eye 226 based on a reflection 232 of the near infra-red light 204 from the pupil 228 at approximately the determined center point 222 of the lens 216. The reflection 232 of the near infra-red light from the pupil 228 of the eye is also shown at 214 as the closest reflection point (or one of the close reflection points) to the determined center point 222 of the lens 216 of the glasses. The eye location module 118 is also implemented to map out the other reflection points 230 from the glasses frame and lenses.

In implementations, the eye location module 118 can determine the reflection 232 of the near infra-red light from the pupil 228 as the closest reflection point from the near infra-red light to the determined center point 222 of the lens 216 of the glasses. The eye location module 118 can locate the pupil 228 of the eye 226 using the determined center point 222 of the lens of the glasses as a starting point of a location search for the pupil of the eye. The eye location module 118 can then perform the location search for the pupil aided by the coordinates of the closest reflection point, and then activate the imager 108 to capture an image of the eye (or eyes) of the user as the captured image 114 for iris authentication of the iris 234 by the iris authentication application 116 based on the pupil 228 of the eye being located. In embodiments, the eye location module 118 can determine the center point 222 of the lens 216 (or the lenses) of the glasses approximately simultaneously with locating the pupil 228 of the eye (or eyes) of the user based on the reflection of the near infra-red light from the pupil.

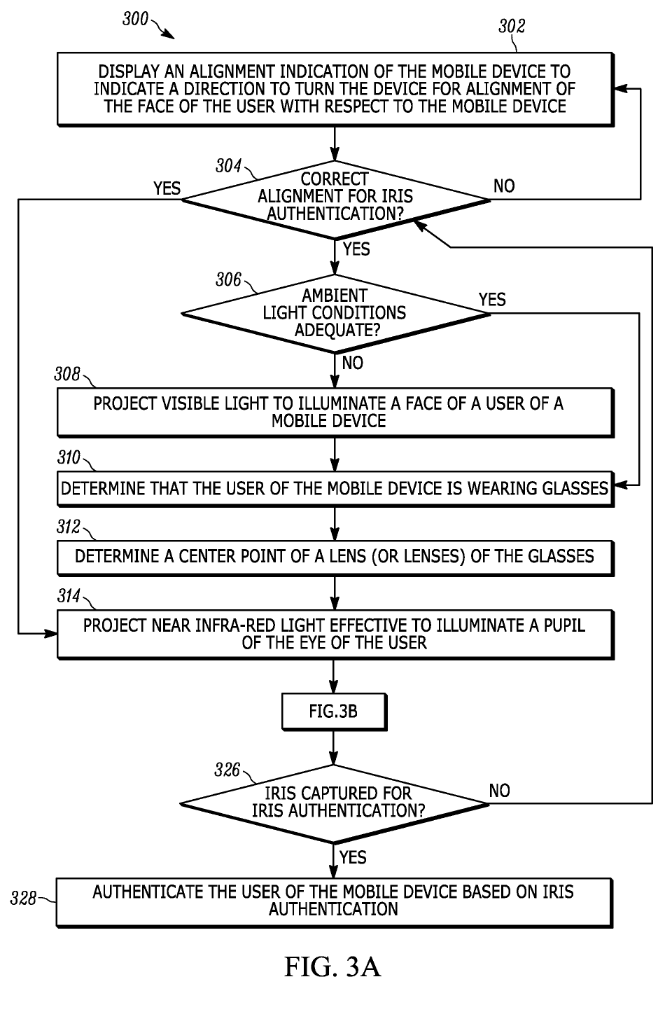

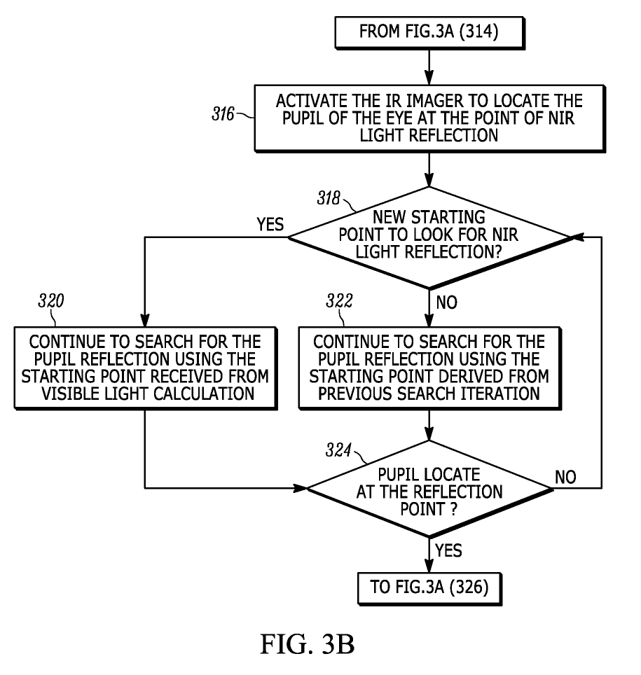

Example method 300 is described with reference to FIGS. 3A and 3B in accordance with implementations of iris acquisition using visible light imaging. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIGS. 3A and 3B illustrate example method(s) 300 of iris acquisition using visible light imaging. The order in which the method is described is not intended to be construed as a limitation, and any number or combination of the described method operations can be performed in any order to perform a method, or an alternate method.

At 302, an alignment indication of the mobile device is displayed to indicate a direction to turn the device for an alignment of the face of the user with respect to the mobile device for locating a pupil of an eye of the user. For example, the alignment indication 122 is displayed in an interface on the display device 120 of the mobile device 100. In the example shown at 202 (FIG. 2), the alignment indication is shown as the dashed line with an arrow to direct the user which way to move the mobile device so that the dashed line is then centered between the eyes as displayed in a preview of the eyes (e.g., a video preview or a still image preview) as shown at 206.

At 304, a correct alignment for iris authentication is determined based on the detected alignment of the face of the user. For example, the eye location module 118 that is implemented by the mobile device 100 determines whether the user is correctly aligned with respect to the imaging system 104 of the mobile device. The alignment indication 122 that is displayed in the interface on the display device 120 of the mobile device 100 shows a correct alignment of the face of the user with respect to the mobile device in the example shown at 206, and the eye location module 118 determines the correct alignment for iris authentication.

If the correct alignment for iris authentication is not determined (i.e., “No” from 304), then the method continues at 302 to display the alignment indication 122 on the display device 120 of the mobile device 100, indicating the alignment adjustment and assisting the user positioning with respect to the mobile device. If the correct alignment for iris authentication is determined (i.e., “Yes” from 304), then parallel (e.g., approximately simultaneous) paths are implemented to locate a pupil 228 of an eye 226 (or the pupils of both eyes) of the user of the mobile device for iris authentication. As described with reference to method actions 306-312, and in more detail below, a determination is made that the user of the mobile device 100 is wearing glasses 208 and the bisection center point 222 of a lens 216 is determined to facilitate the IR processing system acquiring the iris 234 of the eye for iris authentication. Additionally and in parallel, as described with reference to method actions 314-324, near infra-red light (NIR) is projected to illuminate the pupil 228 of the eye 226 (or the pupils of both eyes) of the user, the pupil is located based on a reflection of the NIR light from the pupil, and the IR imager 108 captures an image of the eye for iris authentication.

At 306, a determination is made as to whether ambient light conditions are adequate for determining that the user of the mobile device is wearing glasses. For example, the face of the user of the mobile device 100 can be illuminated utilizing the ambient light; by changing the display device 120 to a white or other illuminating color; or as shown at 210, by projecting the visible light 212 with the light 130 (e.g., a flash or LED) of the front-facing camera device 126.

If the ambient light conditions are not adequate for determining that the user of the mobile device is wearing glasses (i.e., “No” from 306), then at 308, visible light is projected to illuminate a face of a user of the mobile device. For example, the front-facing camera device 126 that is integrated with the mobile device 100 includes the imager 128 and the light 130, such as a flash or LED that emits the visible light 212 used to illuminate the face of the user who is wearing the glasses 208, such as shown at 210. This visible light source can be used in instances when an ambient light sensor (e.g., a sensor 112) detects that there is not sufficient ambient light to illuminate the face of the user.

If the ambient light conditions are adequate to illuminate the face of the user (i.e., “Yes” from 306), or continuing from 308, then a determination is made that the user of the mobile device is wearing glasses at 310. For example, eyeglass detection methods are used to determine the presence of eyeglasses worn by the user, such as utilizing the imager 128 of the camera device 126 to capture a visible light image, and the eye location module 118 utilizing known algorithms and other techniques for face and eyeglass detection of the glasses 208 worn by the user of the mobile device 100. At 312, a center point of a lens of the glasses is determined. For example, the eye location module 118 that is implemented by the mobile device 100 bisects a lens 216 (or both lenses) of the glasses horizontally 218 and vertically 220 to determine the bisection center point 222 of the lens of the glasses.

At 314, near infra-red light is projected to illuminate a pupil of an eye (or pupils of both eyes) of the user. For example, one or more of the LEDs in the LED system (e.g., the NIR lights 106) project the near infra-red light 204 to illuminate the eye 226 (or both eyes) of the user, such as when the correct alignment for iris authentication is determined (i.e., “Yes” from 304). Alternatively or in addition, the near infra-red light 204 is projected to encompass the determined center point 222 of the lens 216 of the glasses effective to illuminate the pupil 228 of the eye of the user, such as when the user is determined to be wearing glasses (at 310) and the center point 222 of the lens 216 is determined (at 312).

Continuing the method 300 with reference to FIG. 3B, at 316, the IR imager is activated to locate the pupil of the eye at the point of near infra-red light reflection from the pupil. For example, the eye location module 118 activates the imager 108 to capture an image of the eye (or eyes) of the user as the captured image 114 to locate the pupil 228 of the eye 226 for iris authentication of the iris 234 by the iris authentication application 116. The eye location module 118 locates the pupil 228 of the eye 226 based on the reflection 232 of the near infra-red light from the pupil. Alternatively or in addition, the pupil 228 of the eye 226 is located based on the reflection 232 of the near infra-red light using the determined center point 222 of the lens 216 of the glasses 208 as a starting point of a location search for the pupil 228 of the eye. Further, the eye location module 118 can determine the reflection 232 of the near infra-red light from the pupil 228 of the eye as the closest reflection point of the near infra-red light to the determined center point 222 of the lens 216 of the glasses. The determined center point 222 of the lens of the glasses is approximate, and the multiple reflection points 230 of the near infra-red light from the glasses frame and lenses can be processed in a priority order based on how close to the bisection center point 222 they are.

At 318, a determination is made as to whether there is a new starting point from which to look for the near infra-red (NIR) light reflection from the pupil of the eye. If there is a new starting point from which to look for the NIR light reflection (i.e., “Yes” from 318), then at 320, the search for the pupil reflection is continued using the starting point determined based on the visible light calculation (e.g., the determined bisection center point of a lens of the glasses as determined by the eye location module 118). If there is not a new starting point from which to look for the NIR light reflection (i.e., “No” from 318), then at 322, the search for the pupil reflection is continued using the starting point derived from a previous search iteration. The method continues from 320 or 322 as a determination as to whether the pupil of the eye has been located at the reflection point of the NIR light. If the pupil 228 of the eye 226 has not been located at the determined reflection point of the NIR light (i.e., “No” from 324), then the method continues at 318 to determine whether there is a new starting point from which to look for the NIR light reflection from the pupil of the eye. If the pupil 228 of the eye 226 has been located at the determined reflection point of the NIR light (i.e., “Yes” from 324), then the method continues at 326 in FIG. 3A.

At 326, a determination is made as to whether the iris of the eye has been captured for iris authentication, and if not (i.e., “No” from 326), then the method continues at 304 to determine a correct alignment of the mobile device for iris authentication; at 306 to determine whether the ambient light conditions are adequate to illuminate the face of the user; and to 308 if needed to project the visible light to illuminate the face of the user of the mobile device, such as to better illuminate the face of the user so that the pupil 228 of the eye (or the pupils of both eyes) can be located. In a further implementation, a final IR iris location can also be input as feedback for the visible light estimation (e.g., implemented by the eye location module 118), such as if the eyeglass lenses are large and the iris may not be actually located at the determined center bisection of the lenses. If the iris of the eye has been captured for iris authentication (i.e., “Yes” from 326), then at 328, the user of the mobile device 100 is authenticated based on iris authentication by the iris authentication application 116.

FIG. 4 illustrates various components of an example device 400 in which embodiments of iris acquisition using visible light imaging can be implemented. The example device 400 can be implemented as any of the computing devices described with reference to the previous FIGS. 1-3, such as any type of client device, mobile phone, tablet, computing, communication, entertainment, gaming, media playback, and/or other type of device. For example, the mobile device 100 shown in FIG. 1 may be implemented as the example device 400.

The device 400 includes communication transceivers 402 that enable wired and/or wireless communication of device data 404 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 400 may also include one or more data input ports 406 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 400 includes a processing system 408 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 410. The device 400 may further include any type of a system bus or other data and command transfer system that couples the various components within the device. A system bus can include any one or combination of different bus structures and architectures, as well as control and data lines.

The device 400 also includes computer-readable storage memory 412 that enable data storage, such as data storage devices that can be accessed by a computing device, and that provide persistent storage of data and executable instructions (e.g., software applications, programs, functions, and the like). Examples of the computer-readable storage memory 412 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 400 may also include a mass storage media device.

The computer-readable storage memory 412 provides data storage mechanisms to store the device data 404, other types of information and/or data, and various device applications 414 (e.g., software applications). For example, an operating system 416 can be maintained as software instructions with a memory device and executed by the processing system 408. The device applications may also include a device manager, such as any form of a control application, software application, signal-processing and control module, code that is native to a particular device, a hardware abstraction layer for a particular device, and so on. In this example, the device 400 includes an IR processing system 418 that implements embodiments of iris acquisition using visible light imaging, and may be implemented with hardware components and/or in software, such as when the device 400 is implemented as the mobile device 100 described with reference to FIGS. 1-3. An example of the IR processing system 418 is the IR processing system 102, which also optionally includes the iris authentication application 116 and/or the eye location module 118, that is implemented by the mobile device 100.

The device 400 also includes an audio and/or video processing system 420 that generates audio data for an audio system 422 and/or generates display data for a display system 424. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 426. In implementations, the audio system and/or the display system are integrated components of the example device. Alternatively, the audio system and/or the display system are external, peripheral components to the example device.

The device 400 can also include one or more power sources 428, such as when the device is implemented as a mobile device. The power sources may include a charging and/or power system, and can be implemented as a flexible strip battery, a rechargeable battery, a charged super-capacitor, and/or any other type of active or passive power source.

Although embodiments of iris acquisition using visible light imaging have been described in language specific to features and/or methods, the subject of the appended claims is not necessarily limited to the specific features or methods described. Rather, the specific features and methods are disclosed as example implementations of iris acquisition using visible light imaging, and other equivalent features and methods are intended to be within the scope of the appended claims. Further, various different embodiments are described and it is to be appreciated that each described embodiment can be implemented independently or in connection with one or more other described embodiments.

1. A method for iris acquisition using visible light imaging, the method comprising:
determining that a user of a mobile device is wearing glasses utilizing ambient light or projected visible light;
determining a center point of a lens of the glasses;
projecting near infra-red light to illuminate at least one eye of the user, the near infra-red light projected to encompass the determined center point of the lens effective to illuminate a pupil of the at least one eye; and
locating the pupil of the at least one eye based on a reflection of the near infra-red light from the pupil at approximately the determined center point of the lens.

2. The method as recited in claim 1, further comprising:
performing said determining the center point of the lens of the glasses approximately simultaneously when said locating the pupil of the at least one eye based on the reflection of the near infra-red light from the pupil.

3. The method as recited in claim 1, further comprising:
determining whether ambient light conditions are adequate for said determining that the user of the mobile device is wearing the glasses; and
projecting the visible light to illuminate a face of the user based on a determination that the ambient light conditions are not adequate, the visible light projected with a light of a front-facing camera device that is integrated with the mobile device.

4. The method as recited in claim 1, further comprising:
locating the pupil of the at least one eye using the determined center point of the lens of the glasses as a starting point of a location search for the pupil of the at least one eye.

5. The method as recited in claim 1, further comprising:
bisecting the lens of the glasses horizontally and vertically to said determine the center point of the lens.

6. The method as recited in claim 1, further comprising:
determining the reflection of the near infra-red light from the pupil as the closest reflection point to the determined center point of the lens of the glasses.

7. The method as recited in claim 1, further comprising:
activating an IR imager to capture an image of the at least one eye of the user for iris authentication based on said locating the pupil of the at least one eye.

8. The method as recited in claim 1, further comprising:
displaying an alignment indication of the mobile device to indicate a direction to turn the mobile device for an alignment of the face of the user with respect to the mobile device for said locating the pupil of the at least one eye.

9. A mobile device, comprising:
an LED system configured to project near infra-red light to illuminate a face of a user of the mobile device;
a memory and processing system to implement an eye location module that is configured to:
determine that the user of the mobile device is wearing glasses;
determine a center point of a lens of the glasses;
initiate the LED system to project the near infra-red light to illuminate at least one eye of the user, the near infra-red light projected to encompass the determined center point of the lens effective to illuminate a pupil of the at least one eye; and
locate the pupil of the at least one eye based on a reflection of the near infra-red light from the pupil at approximately the determined center point of the lens.

10. The mobile device as recited in claim 9, wherein the eye location module is configured to determine the center point of the lens of the glasses approximately simultaneously when the pupil of the at least one eye is located based on the reflection of the near infra-red light from the pupil.

11. The mobile device as recited in claim 9, wherein the eye location module is configured to:
determine from a light sensor input whether ambient light conditions are adequate for a determination of whether the user of the mobile device is wearing the glasses; and
initiate projection of visible light to illuminate a face of the user based on a determination that the ambient light conditions are not adequate, the visible light projected with a light of a front-facing camera device that is integrated with the mobile device.

12. The mobile device as recited in claim 9, wherein the eye location module is configured to locate the pupil of the at least one eye using the determined center point of the lens of the glasses as a starting point of a location search for the pupil of the at least one eye.

13. The mobile device as recited in claim 9, wherein the eye location module is configured to bisect the lens of the glasses horizontally and vertically to determine the center point of the lens.

14. The mobile device as recited in claim 9, wherein the eye location module is configured to determine the reflection of the near infra-red light from the pupil as the closest reflection point to the determined center point of the lens of the glasses.

15. The mobile device as recited in claim 9, wherein the eye location module is configured to activate an IR imager to capture an image of the at least one eye of the user for iris authentication based on the pupil of the at least one eye being located.

16. The mobile device as recited in claim 9, further comprising a display device configured to display an alignment indication of a direction to turn the mobile device for alignment of the face of the user with respect to the mobile device to locate the pupil of the at least one eye.

17. A system, comprising:
a front-facing camera device with a light configured to project visible light to illuminate a face of a person;
a memory and processing system to implement an eye location module that is configured to:
determine that the person is wearing glasses utilizing ambient light or the projected visible light;
determine a center point of a lens of the glasses;
initiate an LED system to project near infra-red light to illuminate at least one eye of the person, the near infra-red light projected to encompass the determined center point of the lens effective to illuminate a pupil of the at least one eye; and
locate the pupil of the at least one eye based on a reflection of the near infra-red light from the pupil at approximately the determined center point of the lens.

18. The system as recited in claim 17, wherein the eye location module is configured to bisect the lens of the glasses horizontally and vertically to determine the center point of the lens.

19. The system as recited in claim 17, wherein the eye location module is configured to determine the reflection of the near infra-red light from the pupil as the closest reflection point to the determined center point of the lens of the glasses.

20. The system as recited in claim 17, wherein the eye location module is configured to activate an IR imager to capture an image of the at least one eye of the person for iris authentication based on the pupil of the at least one eye being located.
